(19) United States
(12) Patent Application Publication
(10) Pub. No.: US 2008/0056924 A1
(43) Pub. Date: Mar. 6, 2008

(54) Volumetric efficiency in a charge cooled or air cooled wankel rotary engine

(75) Inventors: David Wiese, Brooklyn Park, MN (US); Eric Barger, Arlington, OH (US)

Correspondence Address: EMCH, SCHAFFER, SCHAUB & PORCELLO CO, P O BOX 916, ONE SEAGATE SUITE 1980, TOLEDO, OH, 43697, US

(73) Assignee: Thermo Fan

(21) Appl. No.: 11/823,968

(22) Filed: Jun. 29, 2007

Related U.S. Application Data
(60) Provisional application No. 60/817,796, filed on Jun. 30, 2006.

(51) Int. Cl. F01C 1/063; F02F 11/00

(52) U.S. Cl. 418/61.2; 277/594; 451/28

(57) ABSTRACT

An improved Wankel-type rotary engine having a one piece manufactured side sealing system to improve engine oil leakage and combustion chamber lubrication leakage over the entire seal. The rotor of the Wankel-type rotary engine acts like an internal supercharger thereby improving the power output of the engine. An electronic circuit operates to open the peripheral port at a desired RPM to a desired position. The rotor housing for the Wankel-type rotary engine is ground using a horizontal machining center with a custom parameter driven program and is finished in a spiral overlapping process. The seals for the Wankel-type rotary engine are designed and programmed into a Wire Electrical Discharge Machine wherein perfect consistent apex seals are manufactured out of a single block of material.

### CROSS REFERENCE TO RELATED APPLICATION

The present patent application is based upon and claims the benefit of U.S. provisional application No. 60/817,796 filed Jun. 30, 2006.

### Method of Improved Side Sealing for Wankel Rotary Engines

### BACKGROUND OF THE INVENTION

All current Wankel type rotary engines that I know of use a 6 piece side sealing system on each side of the rotor as well as 6 springs on each side of the rotor. This system is a poor design for the following reasons:

Since the slot between each corner seal must be very narrow and also very accurate it is very difficult and time consuming to machine this slot without a custom machine designed specifically for this purpose.

Since the slot between each corner seal can vary slightly in length, each of the 3 side seals on each side of the rotor must be individually fit so as to minimize the gap between the side seal and the corner seal. These custom fit seals must then be kept track of both in position on rotor and direction etc. between the time the seal is fit and the time the engine is assembled. This fitting is very time consuming.

If the fit on the seal is not near perfect, exhaust gasses can leak either at the ends of the side seals or around the edges of the side seals. This leakage can cause reduced performance and possibly sticking seals whereby one or more of the side seals sticks in the groove and in that chamber exhaust gasses leak completely from the combustion chamber causing the engine to need to be torn apart and rebuilt.

The current sealing system causes a groove to be worn on the minor axis of the side housings, which can also cause some combustion chamber leakage and reduced lubrication.

### SUMMARY OF THE INVENTION

My invention is to replace the 6 piece side sealing system with one piece manufactured using technology not available when the 6 piece system was developed. This invention would have the following potential benefits:

Works for any size engine (the current 650 cc design uses stock Mazda components).

Saves 75-95% of the time on machining rotor slots since the slot can be made wider and the seal itself can be made to reduce the contact area with the side housing.

100% consistency from engine to engine and seal to seal (more open tolerances on the rotor machining due to not as critical clearances between rotor and seal).

Cost will be similar to Mazda components for 650 cc and cost will be somewhat proportional to size for other displacements.

Will eliminate the problem of sticking side seals no matter what the circumstances (load is spread out over the entire seal, not just one part of six).

Will reduce or eliminate groove in side housings due to eliminate chance of seal float or rock.

Will improve leak-downs to near 100%, and leak-downs should remain high for a longer period of time, if not for the entire life of the engine due to no gap between side seal and corner seal and elimination of sticking.

Improved compression due to improved leak down.

Improved combustion chamber lubrication due to no lubrication being able to leak past side seals at the ends or around the grooves in the side housings.

Elimination of 3 springs since load is spread out over entire seal.

### Method of Improved Volumetric Efficiency in a Charge Cooled or Air Cooled Wankel Rotary Engine

### BACKGROUND

In a charge cooled or air cooled Wankel rotary engine the incoming charge (fuel and air) or air passes through the rotor between the time it enters the engine to the time it enters the intake chamber. The function of this charge cooling or air cooling is to cool the rotor so that it does not overheat and seize up on the rotor bearing or cause predestination due to the combustion chamber surface being too hot or cause the lubrication to overheat and lose its lubricity among other things. In a normal internal combustion engine (either piston, rotary or otherwise) the Volumetric Efficiency is traditionally around 85% but can never be over 100% (VE is the ratio of the maximum volume of the intake chamber or cylinder to the volume of air that is drawn into the engine on each intake stroke) without some form of external forced induction (such as a turbo charger or supercharger).

### SUMMARY

It has been observed in the current design of the charge cooled rotary engine that if the shape of the rotor is made in a certain way (as it is currently designed), the rotor acts like an internal supercharger at some RPM's and the VE of the engine exceeds 100% at those ROMs thereby improving the power output of the engine at those RPM's. It is further anticipated that the shape of the rotor can be changed to any number of designs to exploit this phenomenon further and extend the RPM range that this occurs in and/or improve the power output further within the affected RPM range.

### Method of Controlling the Peripheral Port on a Charge Cooled or Air Cooled Wankel Rotary Engine

### BACKGROUND

On any Wankel rotary engines that have both a side port(s) and a peripheral port it is desirable to completely close the peripheral port during starting and idling since if the peripheral port is open during starting and idling it is very difficult to pull air into the engine due to the large intake port area (a smaller intake port will create more intake runner velocity whereas a larger intake port would allow more air and fuel into the engine). Therefore some form of butterfly with an associated control must be incorporated in the engine so as to open the peripheral port at a desired RPM to a desired position.

### BRIEF DESCRIPTION OF THE DRAWINGS

FIG. 1 is a representative electronic circuit designed to open the peripheral port of a rotary engine at a desired RPM.

### SUMMARY

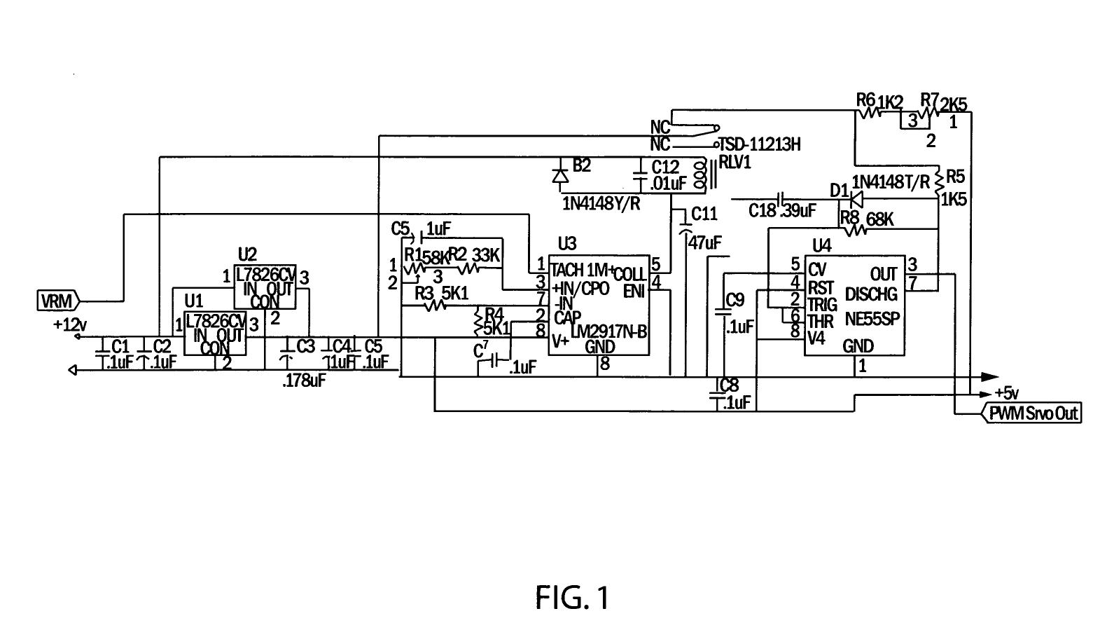

This invention utilizes a custom electronic circuit along with a stock off the shelf servo and a custom butterfly assembly to open the peripheral port at a desired RPM to a desired position. FIG. 1 is the electronic circuit which accomplishes these goals. The circuit requires +12 v DCI a ground and an input from any external pickup on the crankshaft, in this case a Variable Reluctance Magnetic or VRM pickup. The +12 v DC is converted to a +6V DC for use in other areas of the circuit as well as for the Servo control output. The incoming VRM signal is fed to the LM2917N-8 tachometer chip which in turn opens the relay TSC-11213H when the incoming VRM signal reaches a point set by the 50K potentiometer R1. When the relay is closed (up to the VRM signal set by potentiometer R1) the timing signal for the servo is set by resistor R5 which in turn holds the servo in a closed position by the timing chip NE555P. When the relay is opened by the LM2917N-8 tachometer chip, the timing signal for the servo is set by the resistor R6 and the 2K5 potentiometer R7 through the timing chip NE555P. The potentiometer R7 controls the open position of the butterfly by varying the timing signal of the NE555P chip. The output of the circuit includes +6V DC to power the servo, a ground for the servo and a timing signal from 1 to 2 ms repeated approximately every 20 ms.

### Method of Improved Finishing of a Rotor Housing for a Wankel Rotary Engine

### BACKGROUND

On a Wankel rotary engine the ID of the rotor housing is coated with a very hard material which must be ground to give it the required finish and accuracy to be functional. As far as I know, the only way to finish grind the ID of a Wankel Rotary Engine rotor housing is with either a very expensive custom machine specifically designed for grinding rotor housings of a specific size or a very expensive CNC grinder specifically made for grinding which grinds the rotor housing by moving the grinding wheel in and out perpendicular to the face of the rotor housing around the contour of the rotor housing shape.

### SUMMARY

This invention simplifies the grinding process by both utilizing current multi-use equipment (Horizontal Machining Center) with custom parameter driven programs to accomplish a superior ground surface on the ID of a rotor housing without the need for an expensive specialized piece of equipment. The programs are designed so as to allow any diameter and/or thickness grinding wheel to be used. Furthermore, the programs are designed to grind any amount of material out of the ID of the housing since it can vary in thickness from part to part according to the process or material being used for the wear surface. Also, the programs are designed to finish the surface in a spiral overlapping process rather than moving the wheel in and out perpendicular to the rotor housing face. This is important as it maintains a completely smooth surface over the entire surface of the coating.

### Improved Method of Manufacturing Apex Seals for Wankel Rotary Engines

### BACKGROUND

The current widely accepted method of manufacturing apex seals for Wankel rotary engines is to use a custom iron based powdered material which is ten formed in the rough shape of the apex seal. This shape is then finished by various means to obtain the required shape and tolerances. Furthermore, since this shape is relatively soft when it is formed in the powdered metal process, it must be hardened on the wear surface by an electron beam hardening system. This process of manufacturing apex seals is very time consuming and labor intensive.

### SUMMARY

This invention improves on the existing process by not only eliminating 90%+ of the labor required to manufacture the seals, it allows for the use of various materials which are both hardened throughout the seal thereby eliminating the potential of wearing through the hardened area and they are made from materials which can have a much lower wear rate than the powdered iron. The process improvement consists of purchasing a block of the required material out of which many individual apex seals can be manufactured. This block is then shaped to the desired length, width and height and then hardened throughout. Then the block is ground to the desired final length, width and height. Once the block of material out of which several up to hundreds of apex seals will be cut is ready, it is placed in a Wire Electrical Discharge Machine and the final shape of the apex seal desired is cut many times over out of the same block with very little labor required. Once the apex seals are removed from the Wire EDM machine, they are ready to be installed in the engine. This method provides dimensionally perfect consistent apex seals with a very small percentage of labor as compared to the existing technology.

I claim:

1. A Wankel-type rotary engine having a one piece manufactured side sealing system wherein the engine operating load is spread out over the entire seal, and having no gap between the side seal and a corner seal thereby providing improved compression and combustion chamber lubrication.

2. An improved volumetric efficiency in a charge cooled or air cooled Wankel-type rotary engine wherein the rotary engine rotor acts like an internal supercharger at given RPM's and the VE of the engine exceeds 100% at those ROMs thereby improving the power output of the engine at the given RPMs.

3. Apparatus for controlling the peripheral port on a charge cooled or air cooled Wankel-type rotary engine comprising a custom electronic circuit combined with a servo and custom butterfly assembly to open the peripheral port at a desired RPM to a desired position.

4. A method for improved finishing of a rotor housing for a Wankel-type rotary engine wherein the grinding process is simplified by both utilizing a horizontal machining center with a custom parameter driven program to accomplish a superior ground surface on the interior diameter of a rotor housing.

5. The method of claim 4 wherein the program is designed to finish the surface in a spiral overlapping design rather than moving the grinding wheel in and out perpendicular to the rotor housing face.

6. Improved apex seals for a Wankel-type rotary engine comprising shaping the material for the individual apex seals to a desired length, width and height and hardening; grinding the material to the final length, width and height dimension; placing the material in a Wire Electrical Discharge Machine to cut the final shape of the apex seal out of a large block of material.
